(19) United States
(12) Patent Application Publication
(10) Pub. No.: US 2006/0022822 A1
(43) Pub. Date: Feb. 2, 2006

(54) Holster for a portable electronic device

(76) Inventors: Daniel H. Wong, San Jose, CA (US); Michael L. Charlier, Palatine, IL (US); Keith E Kinerk, Fontana, WI (US)

Correspondence Address: MOTOROLA INC, 600 NORTH US HIGHWAY 45, ROOM AS437, LIBERTYVILLE, IL, 60048-5343, US

(21) Appl. No.: 10/903,700

(22) Filed: Jul. 30, 2004

(51) Int. Cl. G08B 13/14

(52) U.S. Cl. 340/568.1; 224/930

(57) ABSTRACT

A holster (100) for holstering portable electronic device (102) and clipping to objects when the portable electronic device is removed therefrom. The holster comprises a body (104) adapted to selectively retain the portable electronic device and a clip (110) carried on the body and adapted to removably couple the body of the holster to an object. The holster includes a sensor (118) a controller (114) and a transmitter to transmit the alert signal to the device. The holster transmits (908) an alert signal or message to the portable electronic device upon the sensing (904) of changed characteristics of the holster.

### FIELD OF THE INVENTION

The present invention relates generally to personal security devices. More particularly the present invention is directed to incorporating a security mechanism into a holster.

### BACKGROUND OF THE INVENTION

Handheld electronic devices, such as cellular radiotelephones are generally small and lightweight, making them portable and easy to carry. As a result, they are carried on the person on a regular basis. The devices are generally carried on the person in a holster which clips to the users belt or clothing such as a pocket for example. However, the holster generally adds little functionality except to fasten the device to the user's person. Furthermore the holster generally does not carry any electronic components therein and as a result the holster provides very limited use.

Users that travel, particularly with public transportation such as by airplane, bus or train, spend time in terminals waiting for the transportation to arrive or depart. This requires the need to keep track of personal items such as luggage making it difficult to attend to other tasks such as work related functions, telephone calls or relaxing.

Accordingly, a system is needed that incorporates personal security into portable electronic devices.

### BRIEF DESCRIPTION OF THE DRAWINGS

FIG. 1 is an exemplary view of the holster and a portable wireless device.

FIG. 2 is an exemplary perspective view of the holster and the portable wireless device.

FIG. 3 is an exemplary elevated view of the holster and the portable wireless device.

FIG. 4 is an exemplary view of a holster.

FIG. 5 is an exemplary block diagram of holster circuitry.

FIG. 6 is an exemplary cross sectional view of a holster and switch.

FIG. 7 is an exemplary cross sectional view of a holster and switch.

FIG. 8 is an exemplary cross sectional view of a holster and switch.

FIG. 9 is an exemplary flow diagram.

### DETAILED DESCRIPTION OF THE DRAWINGS

A holster for a portable handheld electronic device is described. More particularly a holster incorporating security features for communication to the portable wireless device is described.

A device is herein disclosed to aid an individual with personal security. In particular, the device is a holster for holstering an electronic device which can communicate with the portable electronic device wirelessly. The holster is an electronic security device that comprises a body that is adapted to fasten to or selectively retain the portable electronic device. The body includes a controller carried on the body; the controller is coupled to a sensor also carried on the body of the holster. A transmitter is carried on the body and coupled to the controller and transmits information to the portable electronic device in response to the sensor sensing a predetermined characteristic related to the body.

The transmitter of the holster transmits signals to the portable electronic device. The portable electronic device has a receiver to receive the signals transmitted from the holster. When the sensor of the holster senses a characteristic that meets a certain criteria or threshold, a message is transmitted from the holster to the portable electronic device. The message received at the portable electronic device may be an alert or may be a text message that describes the nature of the sensed characteristic sensed by the sensor. The device alerts the user that the sensor of the holster has sensed the predetermined characteristic. Upon sensing the sensed characteristic, the holster may optionally activate an alarm carried on the holster.

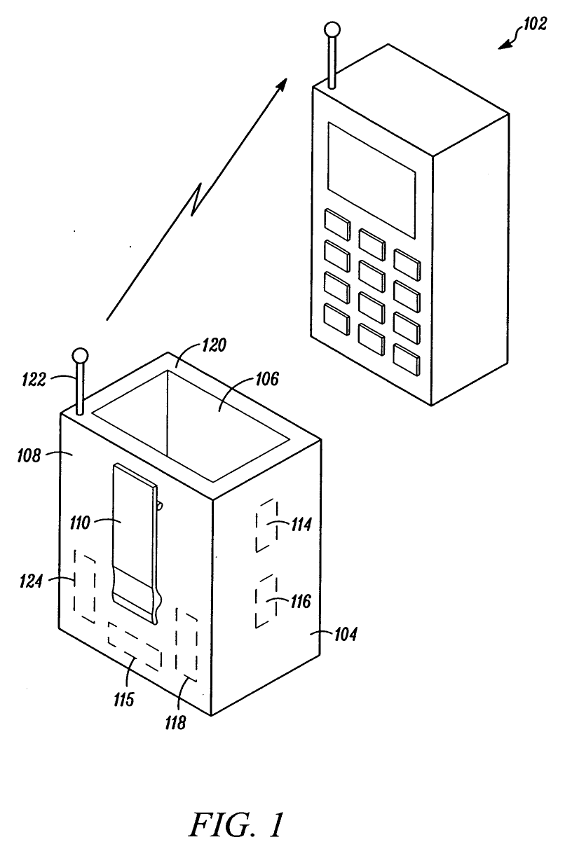

One exemplary embodiment, shown in FIG. 1, illustrates the holster 100 and a portable electronic device which in this exemplary embodiment is wireless communication device 102. The holster 100 includes a body 104 adapted to fasten or couple to the device 102. In this embodiment the body 104 has a void or cavity 106 formed at the top 120 thereof so as to removably receive the wireless communication device 102. In FIG. 1, the holster 100 is shown in a perspective view such that the back side 108 is visible. In this exemplary embodiment the back side 108 has a clip 110 that removably secures (i.e. affixes or couples) the holster 100 (and the device 120 when carried in the holster 100) to other objects. The clip may rigidly fasten the holster to the objects. The clip may also loosely couple the holster to the object. In this exemplary embodiment the clip 110 is adapted to secure to objects such as a belt, luggage strap, briefcase, purse or the like. As one skilled in the art will appreciate, the clip 110 may be adapted to secure to a plurality of different types of surfaces.

Also in FIG. 1 the exemplary holster 100 is shown with a controller 114, a transmitter 116 and a sensor 118, illustrated in dotted line format, to indicate that these components are carried internally on, or enclosed within, the holster 100 in this embodiment. The holster 100 also carries an antenna 122 which is coupled to the transmitter 116. The antenna 122 is carried externally on the holster 100 in this exemplary embodiment however the antenna 122 may be carried internally on the hostler 100 as the controller 114, the transmitter 116 and the sensor 118 are in this exemplary embodiment. When carried externally, the antenna 122 may be a wire whip antenna or a soft wire antenna. It is understood and appreciated by those skilled in the art that the antenna 122 may take on many forms whether internal or external.

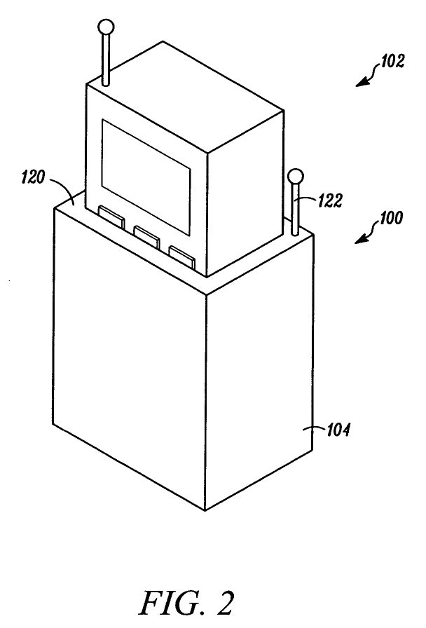

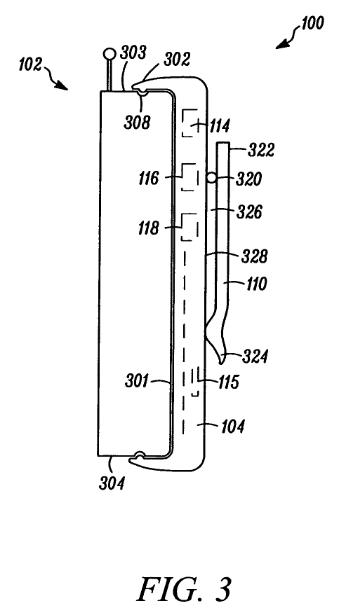

The holster 100 and the portable electronic device 102 are illustrated in FIG. 2 in a holstered configuration wherein the device 102 is engaged with the holster 100. The device 102 is holstered in the cavity 106 of the holster 100 and in this exemplary embodiment is surrounded on four sides and the bottom. A portion of the device 102 may be exposed, as in the exemplary embodiment, or the device 102 may be completely encompassed. As one skilled in the art will appreciate there are numerous ways to holster a device 102. For example, in another exemplary embodiment, illustrated in FIG. 3, the device 102 is surrounded on the back 301, and partially on the top 303 and partially on the bottom 305. In this exemplary embodiment the, top 302 of the holster has a protruding member 304 that extends from the inner surface 306 of the body 104 of the holster 100 and locks or snaps into a detent 308 in the housing 310.

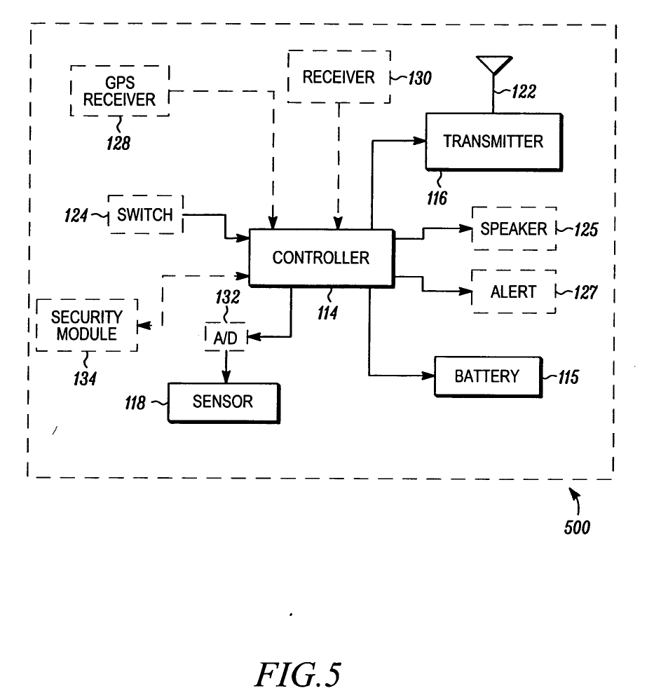

The circuitry 500 (FIG. 5), (i.e. the controller 114, the transmitter 116, sensor 118, antenna 122) of the holster 100 is carried in a portion of the holster 100, the location of which is not material to the exemplary embodiment. In the exemplary embodiment shown in FIG. 3, the circuitry is in the elongated portion 328 of the holster 100 adjacent to the back of the device 102. The circuitry may be carried in a bottom portion of the holster 100 as well for example. The circuitry 500 may be dispersed at different locations about the holster 100 to minimize the space taken by the circuitry 500 and minimize the size of the holster 100, allowing the holster 100 to maintain a thin profile.

The holster 100 may be made out of hard rigid material or a textile such as leather or an imitation thereof. The holster 100 may be a hard material such as plastic or a soft malleable material such as a textile or formable material shapeable to the contour of the device 102.

The clip 110 carried on the holster 100 may take on a plurality of forms. In one exemplary embodiment, illustrated in FIGS. 1 and 3, the clip 110 is a spring loaded clip 110 that is coupled to the holster 100 by a pivot member or hinge 320. The clip 110 is a substantially flat elongated member that runs substantially parallel to the back side 108 of the holster 100 as illustrated in FIG. 3. The hinge 320 is placed near a first clip end 322. The hinge 320 has a spring (not shown) in this exemplary embodiment biasing the clip 110 such that the second clip end 324 is biased toward the holster body 104. In another exemplary embodiment, the clip is not coupled to the holster 100 by a hinge but a pliable member such as plastic. The pliable member may be in the same position as the hinge 320 wherein there is a gap 326 between the holster 100 and the clip 110. The pliable member allows the clip to open when pressed toward the holster at the first clip end 322 increasing the gap between the holster 100 and the second clip end 324 so as to allow the clip 100 and holster 100 to be clipped onto an object.

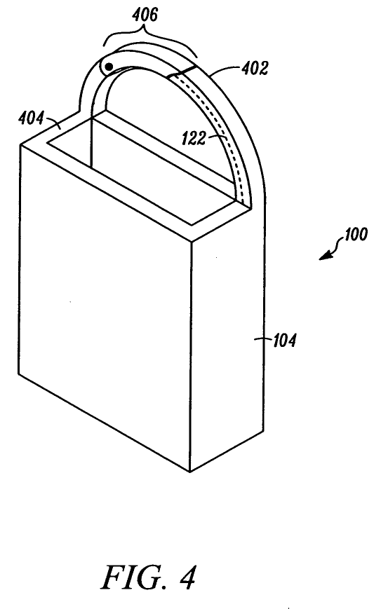

Another exemplary embodiment, shown in FIG. 4, illustrates a clip 402 that is carried on the holster 100 that extends from the top 404. The clip 402 may have a spring loaded portion 406 which allows the user to open the clip 402 to clip the holster 100 on to an object. The clip 402 in this exemplary embodiment arches from one side of the body 408 to the other side of the body 408.

In another exemplary embodiment, the clip is includes a lanyard that is coupled to a string that allows the holster to be hung around the users neck. The user may remove the device 102 from the holster 100 and the holster 100 from around the neck. The holster 100 may then be tied to or hung from another object such as the user's luggage or the like as discussed above while the device remains on the user's person. In this exemplary embodiment the lanyard is removable or unclipable from the clip.

Other examples of what the clip may be affixed to include a purse in one instance or a pocket such as a pocket on an individual's pants. It may also be used to clip the holster 101 to components in a car such as an air vent or other object that holds the device to the vehicle in a useable fashion to the user.

The exemplary circuitry 500 illustrated in FIG. 5 includes the controller 114, the transmitter 116, a power source 115, a sensor 118 and an antenna 122. A switch 124 is coupled to the controller 114 and carried on the body 104 of the holster 100. The switch 124 may optionally be coupled between the controller and the power source 115. An optional speaker 125 or an alert 127 may also be coupled to the controller 114. In addition an optional global positioning system (GPS) receiver 128 and an optional RF receiver 130 may be carried on the body 104 and coupled to the controller 114.

The controller 114, the transmitter 116 and antenna 122 may be designed to transmit information using one or more of a various number of communication protocols. The communication protocol may be a short range protocol such as Bluetooth, Infrared (IrDa) WiFi (802.11) or the like for example. A general dedicated radio frequency (RF) link may also be used.

When the device is removed from the holster 100 the circuitry 500 is turned on automatically or manually by the user. In one embodiment, the circuitry 500 is automatically turned on when the device is removed from the holster 100. In another exemplary embodiment, the circuitry 500 is activated by the user manually toggling the switch 124.

In one exemplary embodiment, the holster 100 carries a receiver 130 to receive signals from the portable electronic device 102. For example, the user may wish to have an alarm sound through the speaker 125 or the alert 127 on the holster. The user may activate a function, e.g. pushing or selecting a button, on the device 102 and the device 102 subsequently transmits a signal to the holster 100, through one of the above mentioned wireless communication protocols, and the receiver 130 receives the signal and the controller 114 thereby controls the speaker 125 or the alert 127. The user may decide to send a signal to the holster 100 after receiving a message from the holster 100 and determining that an alarm needs to be activated on the holster 100.

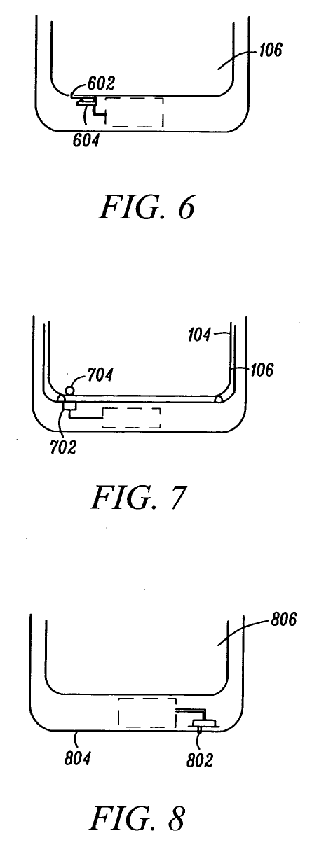

In one exemplary embodiment, the switch 124 is optionally carried on the holster 100 and activated by the operation of holstering the device 102 into and out of the holster 100. The switch may be a micros-witch a hall effect switch, a reed switch or a proximity sensor, or an RF ID sensor. In the exemplary embodiment, illustrated in FIG. 6, the switch 124 is a micro-switch carried on the holster 100 such that at least a portion of the switch, a switch engaging portion 602, is extending outward from the body 104 within cavity 106. The switch engaging portion 602 engages the portable electronic device 102 when the device 102 is inserted into the holster 100 as illustrated in FIG. 6. Insertion and removal of the device 102 activates and deactivates the switch 604. For example, when the device 102 is removed from the holster 100 the switch 124 deactivates thereby signaling the controller 114 in the holster 100 to activate a security mode of the holster 100. The switch 604 may be a micro-switch, as in the exemplary embodiment shown in FIG. 6, having a lever arm coupled between the switch 604 and the switch engaging portion 602. In another exemplary embodiment, the switch may be a reed switch closed by a magnetic field, a Hall Effect switch or the like as Illustrated in FIG. 7.

FIG. 7 shows the holster 100 with a Hall Effect sensor 702. The Hall Effect sensor 702 is activated by a magnet 704 carried on the device 102. When the device 102 is inserted into the holster 100, the magnet substantially aligns with the Hall Effect sensor 702 so as to introduce the Hall Effect sensor 702 to the magnetic field of the magnet 704. A signal is sent to the controller 114 indicating the presence of the device 102 in the holster. When the device 102 is removed, the removal of the magnetic field is sensed by the Hall Effect sensor 702 and the controller receives the signal that the device 102 has been removed from the holster 100 and the security mode is activated.

FIG. 8 illustrates a switch 802 configured on the holster 100 for manual activation of the holster security mode. The switch 802 in this exemplary embodiment is shown protruding from the bottom 804 of the holster 100 however it may extend from any said as along as it is accessible by the user. In one exemplary embodiment the holster is inside the cavity 806 and can only be activated when the device 102 is removed form the holster 100. This may prevent accidental activation of the holster security mode as the switch 802 may catch on clothing or other foreign objects.

The sensor 118 senses a change a predetermined characteristic of the holster 100. In one exemplary embodiment, the sensor is a motion sensor and the predetermined characteristic is motion of the holster or a certain level of motion of the holster 100. The motion sensor senses or detects the motion of the holster and sends signals relaying the sensed motion to the controller 114. The motion sensor sends signals to the controller and the controller 114 compares the motion level to a predetermined motion level and transmits a message when the sensed motion level exceeds the predetermined motion level. The sensor 118 may be a motion sensor to detect motion around the holster 100 such as an infrared or proximity sensor. Another motion sensor may be a mercury switch sensor. The sensor may be an audio sensor such as a microphone that converts audio waves into electric signals which are sent to the controller.

Any of the above signals may be sent as analog signals to the controller 114 or may be sent digitally. The sensor may convert analog signals to digital signals therein. Analog signals may be converted by an analog to digital converter (A/D converter) as they are sent to the controller 114.

The sensor may be a location sensor such as the GPS receiver 128. The controller may constantly be receiving GPS location data from the GPS receiver 128. The controller 114 compares the received location data with pre-stored location data and determines when a predetermined location criteria has been met. The controller may then send a message to the transmitter 116 to be transmitted to the device 102.

An exemplary method for monitoring personal property using the holster includes removing the portable electronic device from the holster 100. The security mode is activated on the holster 100. Next, the holster 100 is placed on a object to be monitored. When the motion sensor senses motion of the object the transmitter of the security holster transmits a message to the portable electronic device in response to the sensing motion. The user receives the message such as an alert on the device 102.

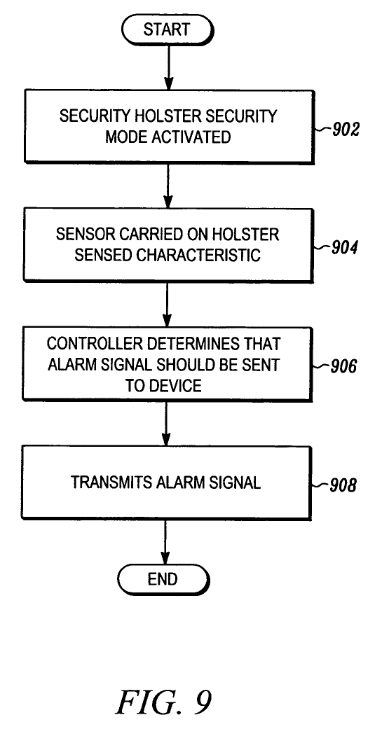

FIG. 9 illustrates an exemplary method of operation of the security holster. In step 902, the security mode is activated on the holster 100. Next, instep 904, the sensor 118 senses a characteristic that matches a stored criteria. The controller 114 determines if the alarm signal should be sent to the device 102. The alarm signal or message is a message to be presented to the user of the device 102 or a command for the device 102 to follow such as sounds an alert from a speaker on the device 102. The alarm signal may also include a command to dial a phone number by the device 102. If the controller 114 determines that the sensed characteristic meets the stored criteria, then the alarm signal is sent in step 908 to the device 908. These steps are further detailed in exemplary embodiments described below.

In one exemplary embodiment a user may want to keep track of luggage while at a transportation terminal such as an airport while waiting for the plane to arrive. If the user wishes to take a nap, it would be quite impossible to keep an eye on the luggage and at the same time. Using the personal security holster 100 and device 102, the user can sleep peacefully without worrying about somebody stealing the luggage. The user may clip the holster 100 to the luggage and activate the motion sensor 118. If the motion sensor 118 detects movement (for example someone has moved the luggage), the holster 100 will alert the user's device 102 by sending a message to the device 102. The user will awake to the special ring tone (or vibration) emitted by the device and can then investigate the cause of the holster 100 movement. If someone is trying to steal his/her luggage, the user can command the holster 100 to emit a high-pitched siren. On the other hand, if the luggage moved because someone accidentally moved it, the user can reset the holster.

In another exemplary embodiment, users are presenting at a tradeshow for example. They will have their attention focused on presenting their products to prospective clients. Consequently, they will find it difficult to monitor the safety of their personal objects such as laptops/briefcases which may be placed behind the booth. The user turns on the holster 100 and clips it to their laptops to activate the security system. Users can even place the holster 100 device into their briefcases to make it less conspicuous. Users can then focus their attention on selling their products to prospective clients, without worrying about someone stealing their belongings. If their belongings are moved, the holster 100 accessory will detect the movement via its motion sensor, and alert the user's mobile phone. The user can then take the appropriate actions to determine the cause of the movement.

In another exemplary embodiment, Parents may be interested in knowing when their kids arrive home from school or other event. The device 102 is placed into the holster 100 and the combination hung on a doorknob say of the front door of the home for example. When the door is opened, the sensor 118 of the holster 100 will detect movement. It can then send a command to the device 102 (e.g. Mom's phone in this exemplary embodiment) retained by the holster 100 to dial a pre-programmed number. In one exemplary embodiment it may call the house phone or another parent's phone. Simultaneously, Mom's phone will ring to alert the kids to pick up the phone so they can speak with the person on the other end (i.e. Dad).

Other functions may be enabled on the device 102 upon the detection of movement of the holster 100. In one exemplary embodiment the device 102 includes integrated camera wherein he images taken therewith may be transmitted to another device. When the holster sense the motion of the door opening the camera can be turned on in response to a command signal sent from the holster 100 transmitter 116 to the device 102. The device may then send images (still or video) for a pre-defined duration or until a command is sent to the device 102.

Dad can use his phone to reset the holster accessory attached to Mom's phone. This function allows users to remotely monitor the security device from another mobile device.

While the invention has been described in detail above, the invention is not intended to be limited to the specific embodiments as described. It is evident that those skilled in the art may now make numerous uses, modifications of, and departures from the specific embodiments described herein without departing from the inventive concepts.

What is claimed is:

1. An electronic device holster comprising:
a body adapted to selectively retain a portable electronic device;
a clip carried on the body and adapted to removably couple the body to an object;
a controller carried on the body;
a sensor carried on the body and coupled to the controller; and
a transmitter carried on the body and coupled to the controller wherein the transmitter is capable of transmitting information to the portable electronic device in response to the sensor sensing a predetermined characteristic related to the body.

2. The holster of claim 1, wherein the sensor is a motion sensor.

3. The holster of claim 2, wherein the motion sensor is an accelerometer, a mercury switch, a proximity sensor or a location sensor.

4. The holster of claim 1, wherein the body includes a cavity for receiving the portable electronic device.

5. The holster of claim 1, further comprising a switch carried on the body and wherein the switch is electrically coupled to the controller.

6. The holster of claim 5, wherein the switch is carried on the body and engagable with the portable electronic device.

7. The holster of claim 6, wherein the switch is a microswitch a hall effect switch, a reed switch or a proximity sensor, or an RF ID sensor.

8. The holster of claim 6 wherein the switch is switched to a first switch position as a result of the portable electronic device being retained by the body of the holster, and wherein
the switch is switched to a second switch position as a result of the portable electronic device being removed from the body of the holster.

9. The holster of claim 8, wherein the first switch position is an off position such that power is not supplied to the controller.

10. A holster for an electronic device comprising:
a holster body adapted to couple to a portable electronic device,
a clip carried on the holster body;
a controller carried on the holster body;
a sensor coupled to the controller;
a transmitter coupled to the controller; and
a security module receiving signals from the sensor sensing a characteristic of the holster and generating a message to be transmitted by the transmitter to the electronic device.

11. A security module couplable to wireless communication device comprising:
a security module housing;
a first fixturing means to removably fixture the security module housing to a wireless communication device;
a second fixturing means to selectively fixture the security module housing to an object;
a sensor carried on the security module housing;
a controller electrically coupled to the sensor;
a switch coupled between the controller and a power source;
a transmitter electrically coupled to the controller; and
a security mode module receiving information from the sensor and generating a message to be transmitted by the transmitter to the wireless communication device.

12. The device of claim 11, wherein the security module housing further comprising a speaker electrically coupled to the controller.

13. The device of claim 11, wherein the sensor is a motion sensor, infrared sensor, proximity sensor or light sensor.

14. The device of claim 11, wherein the generated message to be transmitted by the transmitter comprises an alert message.

15. The device of claim 14, wherein the generated message to be transmitted by the transmitter further comprises a dial command.

16. A method for monitoring personal property comprising:
placing a security holster on a object to be monitored;
sensing motion of the object with a sensor on the security holster; and
transmitting a message from a transmitter carried on the holster to a wireless communication device in response to the sensing motion.
